(19) United States
(12) Patent Application Publication
(10) Pub. No.: US 2026/0219558 A1
(43) Pub. Date: Jul. 30, 2026

(54) BRACKET AND IMAGING ASSEMBLY

(71) Applicant: TOUCAM TECHNOLOGY INC., Toronto (CA)

(72) Inventor: Frederick Christopher CANDLER, Toronto (CA)

(21) Appl. No.: 19/141,561

(22) PCT Filed: Dec. 21, 2023
(86) PCT No.: PCT/CA2023/051741

§ 371 Date: Jun. 20, 2025

Related U.S. Application Data
(60) Provisional application No. 63/434,454, filed on Dec. 21, 2022.

(51) Int. Cl. G03B 17/56; F16M 11/04; F16M 11/20; F16M 13/02; G06F 1/16; G06T 5/50

(52) U.S. Cl. CPC G03B 17/561; F16M 11/048; F16M 11/2014; F16M 13/022; G06F 1/1686; G06T 5/50; G06T 2207/10016; G06T 2207/20221

(57) ABSTRACT

A bracket and imaging assembly comprises an attachment arm configured to engage a computing device component; a swing arm hinged to the attachment arm and pivotable relative thereto between an extended condition and a collapsed condition; a slider accommodated by the swing arm, the slider being slidable longitudinally relative to the swing arm between a retracted condition and an extended condition; and an imaging device on the slider.

### CROSS-REFERENCE TO RELATED APPLICATION

This application claims the benefit of U.S. Provisional Application No. 63/434,454 filed on Dec. 21, 2022 and entitled “Bracket and Imaging Assembly”, the entire content of which is incorporated herein by reference.

### FIELD

The subject disclosure relates to a bracket and imaging assembly.

### BACKGROUND

Mixed reality, document scanning, and interactive systems that include cameras to capture images of physical, real-world scenes and display the captured images on displays of computing devices are known in the art. For example, U.S. Pat. No. 8,475,059 discloses an image capturing device in the form of a webcam that includes a camera housing configured to house a set of electronic modules for generating a video stream from captured light. The camera housing includes a camera opening configured to let light enter the camera housing to be captured by the set of electronic modules. The webcam further includes a camera-housing base rotationally coupled to the camera housing, and includes a mounting base rotationally coupled to the camera-housing base and that is configured to hold the webcam on a computer monitor. The camera housing is configured to rotate with respect to the camera-housing base to face the camera opening toward the mounting base or face the camera housing opening away from the mounting base. The webcam further includes a first hinge rotationally coupling the mounting base to the camera-housing base. With the camera opening facing toward the mounting base, the first hinge is configured such that the mounting base is foldable onto the camera opening to cover the camera opening.

U.S. Pat. No. 11,055,817 discloses a document imaging apparatus that includes a digital imaging unit. The digital imaging unit contains optics that having an infinite focal length. The document imaging apparatus also includes a processor that is coupled to the digital imaging unit and that is configured to cause the digital imaging unit to zoom in or zoom out in real-time while maintaining a resolution value of stored images constant. A non-transitory storage medium stores images obtained from the digital imaging unit and a display displays the stored images. A folding suspension arm supports the digital imaging unit at a distance from a target to be imaged.

U.S. Pat. No. 7,551,780 discloses a mixed media reality (MMR) system and associated techniques. The MMR system provides mechanisms for forming a mixed media document that includes media of at least two types (e.g., printed paper as a first medium and digital content and/or a web link as a second medium). In one particular embodiment, the mixed media document may also include hotspot images that uniquely identify a user associated with the mixed media document. Such individualized mixed media documents are used to identify users of the mixed media document, when orders for products or services are made using the mixed media documents through the MMR system.

While systems that include peripheral imaging devices are available, alternatives are desired. It is therefore an object to provide a novel bracket and imaging assembly.

This background serves only to set a scene to allow a person skilled in the art to better appreciate the following brief and detailed descriptions. Therefore, none of the above discussion should necessarily be taken as an acknowledgement that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of claimed subject matter.

Accordingly, in one aspect there is provided a bracket and imaging assembly comprising: an attachment arm configured to engage a computing device component; a swing arm hinged to the attachment arm and pivotable relative thereto between an extended condition and a collapsed condition; a slider accommodated by the swing arm, the slider being slidable longitudinally relative to the swing arm between a retracted condition and an extended condition; and an imaging device on the slider.

In one or more embodiments, in the retracted condition, the slider and imaging device are accommodated by the swing arm. In the collapsed condition, the swing arm and the attachment arm matingly engage. When the swing arm and the slider are in extended conditions, the imaging device is configured to image a physical desktop or surface.

In one or more embodiments, the imaging device is positioned on the slider adjacent or near its free distal end.

In one or more embodiments, the attachment arm is configured to engage a display component of the computing device. In one form, the attachment arm is configured to engage the display component of a portable computing device. In one form, the attachment arm comprises a channel configured to accommodate an upper edge of the display component. The channel may frictionally engage the upper edge of the display component.

In one or more embodiments, the imaging device comprises at least one camera having at least one lens and a downwardly facing field of view (FOV) when the attachment arm is in engagement with the computing device component. The at least one camera may either be removably attached to the slider or fixedly attached to the slider. In one form, the at least one camera is connectable to the computing device via a universal serial bus (USB) connection.

In one or more embodiments, the bracket and imaging assembly further comprises a retaining mechanism to maintain the angle of the swing arm relative to the attachment arm in the extended condition. In one form, the retaining mechanism comprises mating formations carried by the swing arm and the attachment arm.

In one or more embodiments, the swing arm comprises a channel in which the slider slides and wherein the channel comprises a stop to limit longitudinal extension of the slider relative to the swing arm.

In one or more embodiments, the bracket and imaging assembly further comprises at least one non-transitory computer readable medium embodying instructions, which when executed by one or more processing units, causes the one or more processing units to merge a video stream or image frames captured by the imaging device with a video stream or image frames captured by another imaging device. In one form, the video stream or image frames captured by the imaging device is a physical desktop view and the video stream or images frames captured by the another imaging device is a user view.

### BRIEF DESCRIPTION OF THE DRAWINGS

Embodiments will now be described by way of example only with reference to the accompany drawings in which:

FIG. 1 is a front perspective view of a bracket and imaging assembly in an extended condition in accordance with the subject disclosure;

FIG. 2 is another front perspective view of the bracket and imaging assembly of FIG. 1 in the extended condition;

FIG. 3 is another front perspective view of the bracket and imaging assembly of FIG. 1 in the extended condition;

FIG. 4 is a rear perspective view of the bracket and imaging assembly of FIG. 1 in the extended condition;

FIG. 5 is an exploded front perspective of view of the bracket and imaging assembly of FIG. 1;

FIG. 6 is an exploded rear elevational view of the bracket and imaging assembly of FIG. 1;

FIG. 7 is a front perspective view of the bracket and imaging assembly of FIG. 1 in a partially collapsed condition;

FIG. 8 is another front perspective view of the bracket and imaging assembly of FIG. 1 in the partially collapsed condition;

FIG. 9 is a front perspective view of the bracket and imaging assembly of FIG. 1 in a fully collapsed condition;

FIG. 10 is another front perspective view of FIG. 1 of the bracket and imaging assembly in the fully collapsed condition;

FIG. 11 is a front elevational view of the bracket and imaging assembly in the fully collapsed condition;

FIG. 12 is a rear perspective view of the bracket and imaging assembly in the fully collapsed condition;

FIG. 13 is a front perspective view of the bracket and imaging assembly of FIG. 1 engaged with a display component of a portable computing device;

FIG. 14 is another front perspective view of the bracket and imaging assembly of FIG. 1 engaged with the display component of the portable computing device;

FIG. 15 is another front perspective view of the bracket and imaging assembly of FIG. 1 engaged with the display component of the portable computing device;

FIG. 16 is a schematic block diagram of the portable computing device of FIG. 13;

FIG. 17 is a front perspective view of the bracket and imaging assembly of FIG. 1 engaged with a stand-alone monitor of a computing device;

FIG. 18 is a perspective view of an attachment arm of an alternative embodiment of a bracket and imaging assembly in accordance with the subject disclosure;

FIG. 19 is a perspective view of a swing arm of the bracket and imaging assembly of FIG. 18;

FIG. 20 is an exploded perspective view of a slider of the bracket and imaging assembly of FIG. 18; and

FIG. 21 is a perspective view of a hinge component of the bracket and imaging assembly of FIG. 18.

### DETAILED DESCRIPTION

The foregoing brief description, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” or “embodiment” means that one or more feature, structure, element, component, characteristic and/or operational step described in connection with the example or embodiment is included in at least one implementation of the subject matter according to the subject disclosure. Thus, the phrases “an example”, “another example”, “an embodiment”, “another embodiment” and similar language throughout the subject disclosure may, but do not necessarily, refer to the same example or embodiment. Further, the subject matter characterizing any one example or embodiment may, but does not necessarily, include the subject matter characterizing any other example or embodiment.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

Reference herein to “configured” denotes an actual state of configuration that fundamentally ties the element or feature to the physical characteristics of the element or feature preceding the phrase “configured to.”

It will be understood that when an element or feature is referred to as being “on”, “attached” to, “connected” to, “coupled” to, “contacting”, “fixed” to etc. another element or feature, that element or feature can be directly on, attached to, connected to, coupled to, or contacting the other element or feature or intervening elements may also be present. In contrast, when an element or feature is referred to as being “directly” on, “directly attached” to, “directly connected” to, “directly coupled” to, “directly contacting”, “directly fixed” to etc. another element or feature, there are no intervening elements or features present. Similarly, it will be understood that when an element is referred to as being “directly between” other elements, that element is positioned between the other elements without any intervening elements. In contrast, when an element is referred to as being “between” other elements, that element is positioned between the other elements but intervening elements may also be present.

It will be understood that spatially relative terms such as “bottom”, “under”, “below”, “lower”, “over”, “upper”, “top”, “front”, “back”, “rear”, “side” and the like, may be used herein for ease of describing the relationship of an element or feature to another element or feature as depicted in the figures. The spatially relative terms can however, encompass different orientations in use or operation in addition to the orientation depicted in the figures.

As used herein, the terms “approximately”, “about”, “generally”, “substantially” etc. represent an amount or characteristic close to the stated amount or characteristic that still performs the desired function or achieves the desired result. For example, the terms “approximately” and “about” in reference to a stated amount include amounts that are within engineering or design tolerances of the stated amount that would be readily appreciated by a person skilled in the art. Similarly, for example, the term “substantially” in reference to a stated characteristic of an element includes elements that nearly completely provide the stated characteristic, and the term “generally” in reference to a stated characteristic of an element includes elements that predominately provide the stated characteristic.

Unless otherwise indicated, the terms “first”, “second” etc. are used herein merely as labels, and are not intended to impose ordinal, positional, or hierarchical requirements on the elements to which these terms refer. Moreover, reference to a “second” element does not require or preclude the existence of a lower-numbered element (e.g., a “first” element) and/or a higher-numbered element (e.g., a “third” element).

In the subject disclosure, a bracket and imaging assembly is described that comprises an attachment arm configured to engage a computing device component, a swing arm hinged to the attachment arm and pivotable relative thereto between an extended condition and a collapsed condition, a slider accommodated by the swing arm, the slider being slidable longitudinally relative to the swing arm between a retracted condition and an extended condition, and an imaging device on the slider.

The imaging device is configured to capture a video stream or image frames of a physical desktop or surface on which documents or pages are placed that can be combined with another video stream or image frames, such as a frontal user view captured by a camera of the computing device or by another imaging device, to create a dual view that can be displayed on the computing device and/or shared with other computing devices.

In one exemplary use, the attachment arm is positioned to engage the display component of a portable computing device such as a laptop computer. The swing arm is pivoted relative to the attachment arm so that the swing arm extends beyond the side edge of the laptop computer at a desired angle. The slider is then extended longitudinally relative to the swing arm so that the field of view of the imaging device on the slider is aimed at the physical desktop or surface on which the laptop computer rests.

Video or image frames captured by the imaging device can be presented on the laptop computer display component together with the frontal user view using a “share screen” or “virtual camera” function of an executing application on the laptop computer allowing the frontal user view and the physical desktop view to be displayed in the dual view simultaneously thereby enhancing the interactive experience. When not in use, the bracket and imaging assembly can be collapsed into a compact form to facilitate storage and/or portability. Further specifics of the bracket and imaging assembly and its use will now be described.

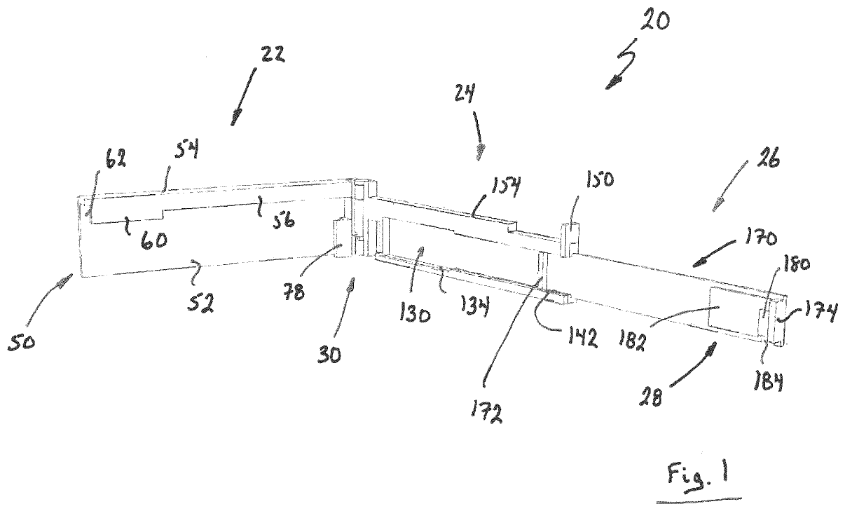

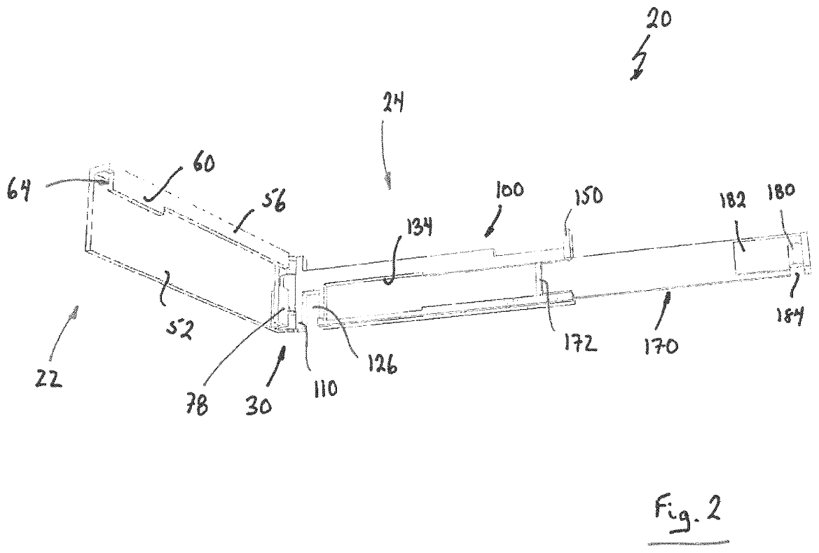

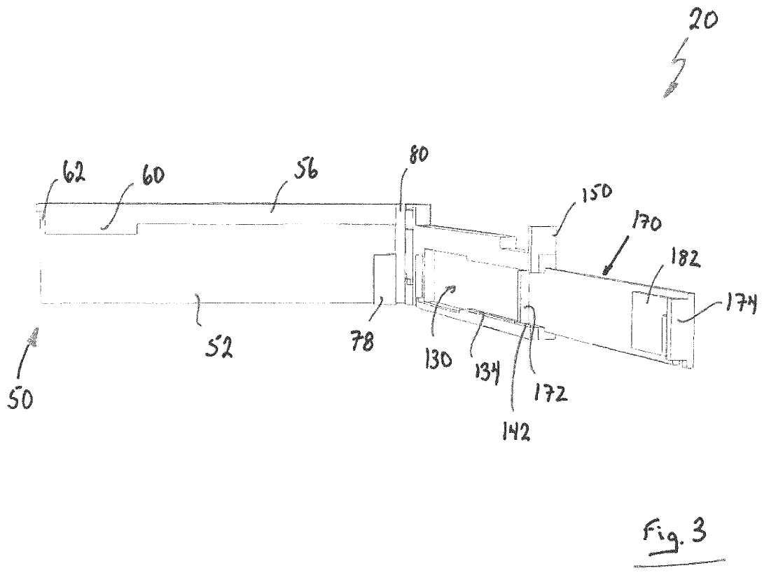

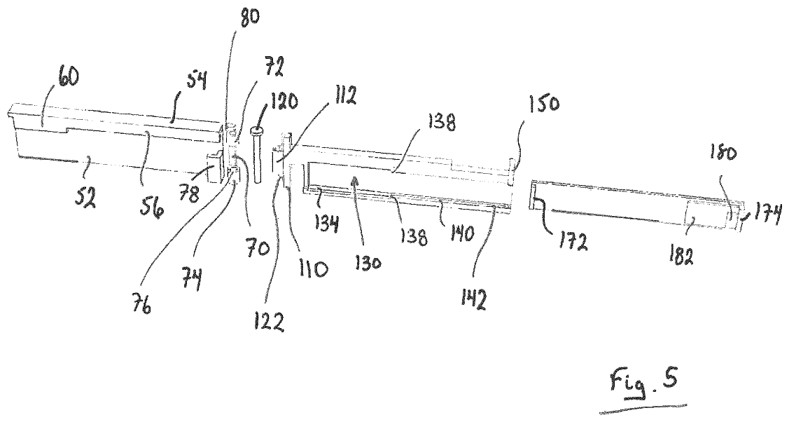

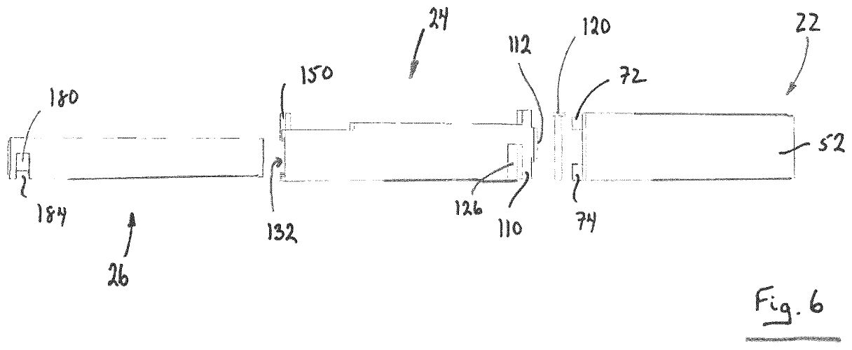

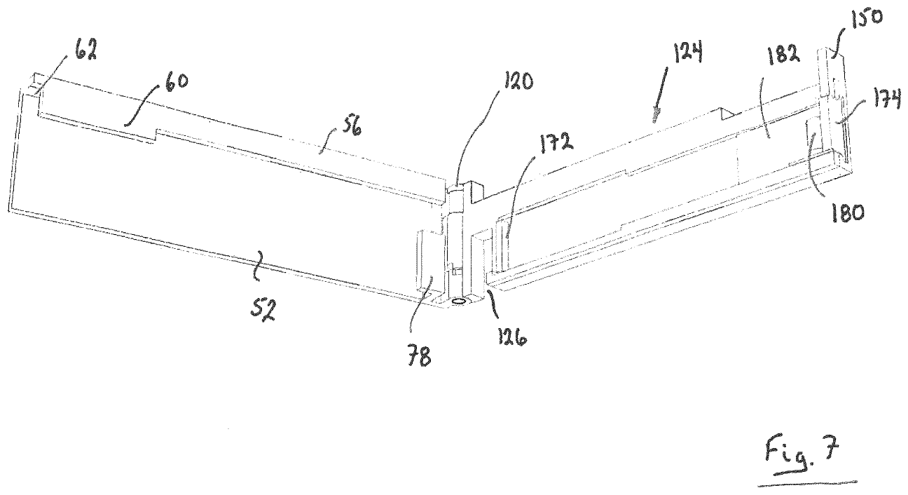

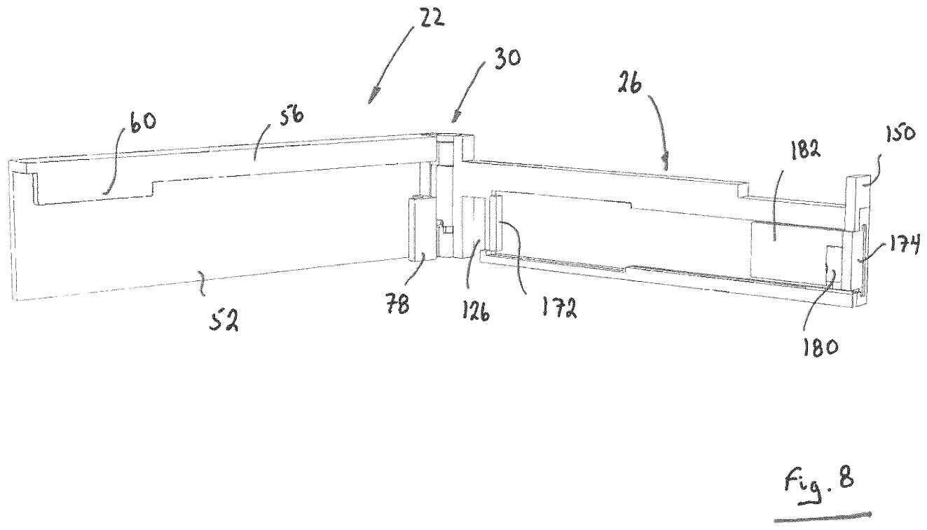

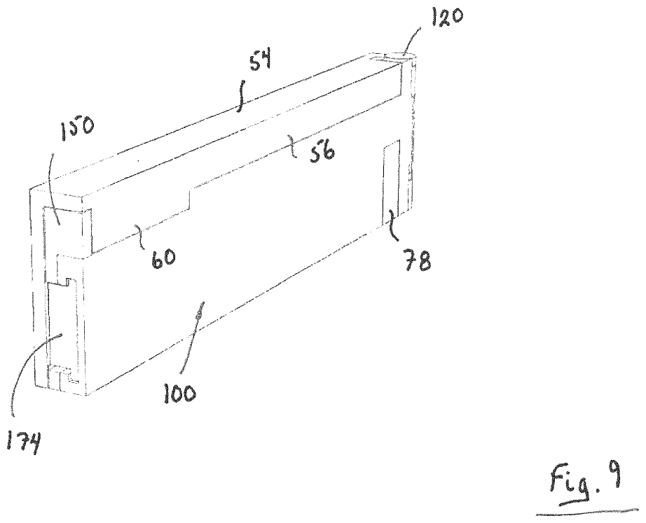

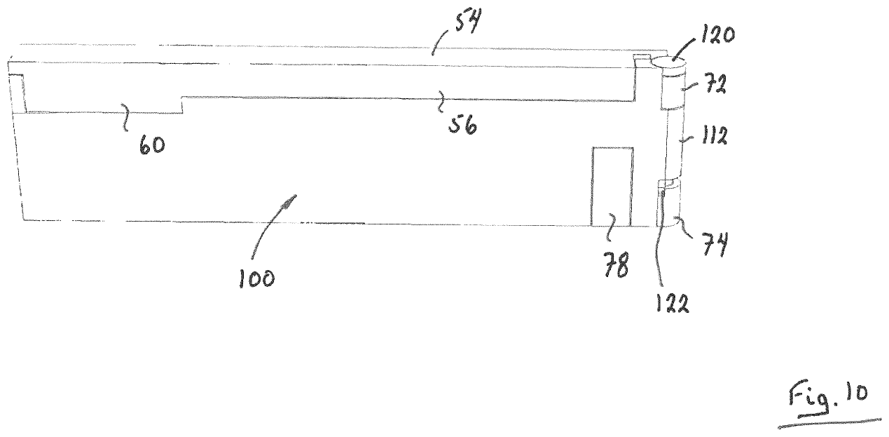

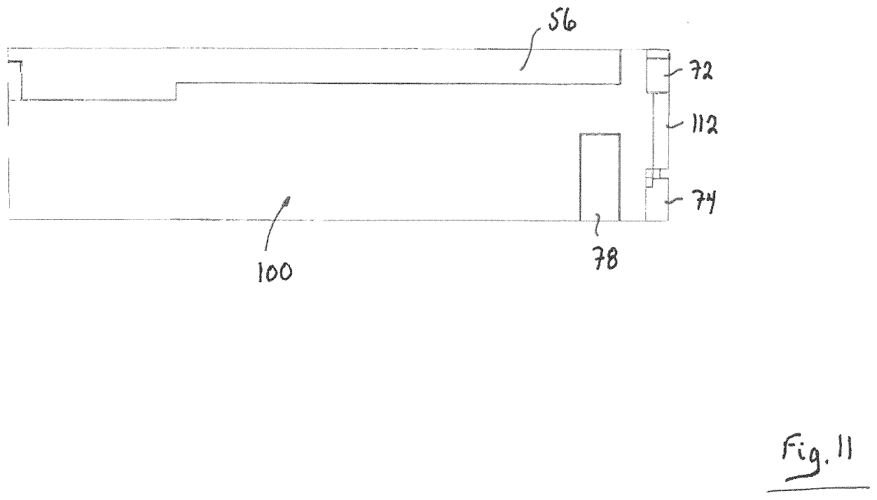

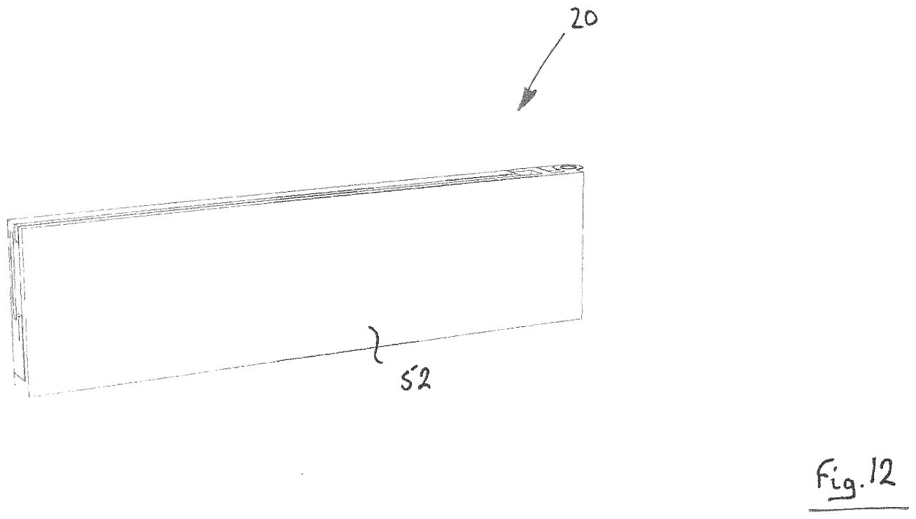

Turning now to FIGS. 1 to 12, an exemplary bracket and imaging assembly configured to engage a computing device display component is shown and is generally identified by reference numeral 20. FIGS. 1 to 4 show the bracket and imaging assembly 20 in an in-use extended condition. FIGS. 5 and 6 show the bracket and imaging assembly 20 exploded to better illustrate components of the bracket and imaging assembly 20. FIGS. 7 and 8 show the bracket and imaging assembly 20 in a partially collapsed condition and FIGS. 9 to 12 show the bracket and imaging assembly 20 in a fully collapsed condition.

In this embodiment, the bracket and imaging assembly 20 comprises four (4) primary components, namely an attachment arm 22, a swing arm 24, a slider 26, and an imaging device 28. Attachment arm 22 and swing arm 24 are physically coupled via a hinge 30 allowing the attachment arm 22 and swing arm 24 to pivotally rotate with respect to one another as will be described. Slider 26 is coupled to the swing arm 24 and is longitudinally slidable relative to the swing arm 24 as will also be described. Imaging device 28 is positioned adjacent or near to the free distal end of the slider 26 and has a downwardly oriented field of view (FOV) when the bracket and imaging assembly 20 is in engagement with the computing display component. In this case, the field of view of the imaging device 28 can be aimed at a physical desktop or surface allowing documents or pages placed on the physical desktop to be imaged providing the imaging device 28 with a physical desktop view.

In this embodiment, the attachment arm 22 comprises a generally rectangular, unitary body 50 formed of plastic or other suitable material. The body 50 is configured to define a major, generally planar rear wall 52, a generally planar top wall 54 along the upper edge of the rear wall 52, and a minor, generally planar front wall 56 depending from the front edge of the top wall 54 and that is spaced forwardly of the rear wall 54. The top wall 54 extends from the free distal end of the body 50 to adjacent the hinge 30. The front wall 56 includes an upset 60 adjacent the free distal end of the body 50 and a cut-out 62 at the free distal end of the body 50. The front wall 56, top wall 54, and the upper portion of the rear wall 52 define a channel 64.

The channel 64 in this embodiment is dimensioned to accommodate the upper edge of the display component of a portable computing device such as a laptop computer. To avoid sliding of the attachment arm 22 along the upper edge of the display component, one or more interior surfaces of the channel 64 may be configured to frictionally engage the upper edge of the display component. As will be appreciated by those of skill in the art, this may be achieved in a number of ways such as by providing material (e.g. rubber) or formations on one or more interior surfaces of the channel 64 that resist sliding movement between the attachment arm 22 and the upper edge of the display component. Alternatively, one or more magnets may be provided on the attachment arm 22 to magnetically couple the attachment arm 22 and the display component thereby to resist sliding movement between the attachment arm 22 and the display component. Still alternatively, the channel 64 may be dimensioned so that the attachment arm 22 and upper edge of the display component engage in a friction fit thereby to resist sliding movement between the attachment arm 22 and the display component.

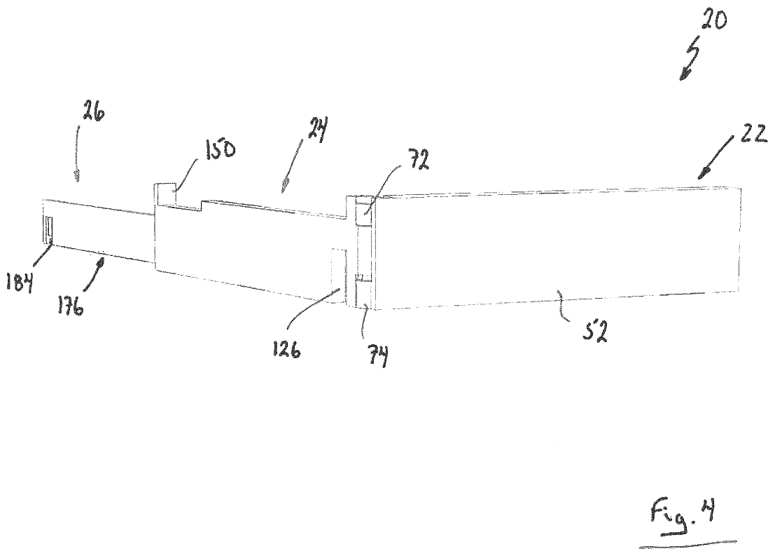

In this embodiment, the end of the body 50 opposite its free distal end is configured to define components of the hinge 30 (best seen in FIGS. 4 to 6). In particular, the end of the body 50 includes a hinge post 70. Vertically spaced upper and lower knuckles 72 and 74 are provided on the hinge post 70. The lower knuckle 74 has a notch 76 provided in its upper surface. An L-shaped angle 78 is provided on the rear wall 52 beneath the top and front walls 54 and 56 and is inwardly spaced from the hinge post 70 in line with the end of the top wall 54. The space between the hinge post 70 and the L-shaped angle 78, top wall 54, and front wall 56 defines a hinge post receiving gap 80.

In this embodiment, the swing arm 24 also comprises a unitary body 100 formed of plastic or other suitable material. The body 100 of the swing arm 24 has a shape that is substantially complimentary to the shape of the attachment arm body 50 allowing the attachment arm 22 and swing arm 24 to matingly engage and nest into a compact configuration (best seen in FIGS. 9 to 12) when the attachment arm 22 and swing arm 24 are folded over and onto one another as will be described.

In this embodiment, the body 100 has a free distal end and an opposite end that is configured to define the remaining components of the hinge 30. In particular, the end of the body 100 includes a hinge post 110. A central knuckle 112 is provided on the hinge post 110 that is aligned with the upper and lower knuckles 72 and 74 on hinge post 70 to define the barrel of the hinge 30. A hinge pin 120 is received by the barrel of the hinge 30 thereby to engage the attachment arm 22 and swing arm 24. A detent 122 is provided at the bottom of the central knuckle 112 that is sized and shaped to be received by the notch 76 in the lower knuckle 74.

A generally rectangular opening 126 is provided through the body 100 adjacent the hinge post 110 that is sized and shaped to accommodate the L-shaped angle 78. A recess is provided in the front of the body 100 that extends from adjacent the opening 126 to the free distal end of the body 100 defining a slider channel 130. The upper and lower surfaces 134 of the slider channel 130 have aligned shoulders 138 therealong providing a step in the width of the slider channel 130 intermediate the length of the body 100. Slider receiving grooves 140 are provided in both the upper and lower surfaces 134 of the slider channel 130. The lower surface 134 of the slider channel 130 has a ramp or ridge 142 formed thereon adjacent the free distal edge of the body 100. As will be appreciated, the ramp or ridge may alternatively be formed on the upper surface of the slider channel 130 or ramps or ridges 142 may be formed on both the lower and upper surfaces 134 of the slider channel.

An upright 150 is provided at the free distal end of the body 100. The upper surface 154 of the body 100 is notched between the hinge post 110 and the upright 150 so that the profile of the upper surface 154 is complimentary to the shape of the front wall 56.

The slider 26 also comprises a generally rectangular, unitary body 170 formed of plastic or other suitable material. Posts 172 and 174 are provided at opposite ends of the body 170. The upper and lower edges of the body 170 are received in the slider receiving grooves 140 allowing the slider 26 to slide longitudinally relative to the swing arm 24 between the extended condition as shown in FIGS. 1 to 4 and the retracted condition as shown in FIGS. 7 and 8.

The imaging device 28 in this embodiment comprises a downwardly aimed camera 180 having one or more lenses and a printed circuit board 182 including the circuitry required to support the camera 180 and transmit captured video or image frames to the portable computing device. An opening 184 is provided in the body 170 adjacent the post 174 and is configured to accommodate the camera 180. Although not shown, a cable extends from the printed circuit board 182 and terminates at a universal serial bus (USB) connector configured to plug into the portable computing device to provide power to the imaging device 28.

When it is desired to stow or transport the bracket and imaging assembly 20, the slider 26 can be pushed so that it slides longitudinally into the slider channel 130 of the swing arm 24 until the post 174 aligns with the free distal end of the swing arm 26 as shown in FIGS. 7 and 8. With the slider 26 fully accommodated within the slider channel 130 of the swing arm 24 and with the swing arm 24 positioned along the hinge pin 120 so that the upper surface of the central knuckle 112 is in close proximity to the lower surface of the upper knuckle 72 and the detent 122 is clear of the lower knuckle 74 (best seen in FIG. 8), the attachment arm 22 and swing arm 26 can be pivotally rotated about the hinge 30 relative to one another to bring the attachment arm 22 and the swing arm 24 towards one another. Due to the complimentary nature of the shapes of the attachment arm 22 and swing arm 24, as the attachment arm 22 and swing arm 24 are brought towards one another, the opening 126 in the swing arm 24 receives the L-shaped angle 78, the hinge post receiving gap 80 receives the hinge post 110, the upper surface 154 of the swing arm body 100 passes beneath the front wall 56 of the attachment arm body 50, and the upright 150 is received by the cut-out 62.

When the attachment arm 22 and swing arm 24 have been fully brought into mating engagement, the bracket and imaging assembly 20 takes on a compact rectangular configuration as best shown in FIGS. 9 to 12. In this fully collapsed condition, the attachment arm 22 and swing arm 24 nest to form an enclosed case for the camera 180 and printed circuit board 182. In this configuration, the friction between the attachment arm 22 and the swing arm 24 is sufficient to retain the attachment arm 22 and swing arm 24 in position and inhibit accidental or unintended pivoting of the swing arm 24 relative to the attachment arm 22. With the bracket and imaging assembly 20 in this fully collapsed condition, the bracket and imaging assembly 20 can be easily transported while ensuring the camera 180 and printed circuit board 182 remain protected.

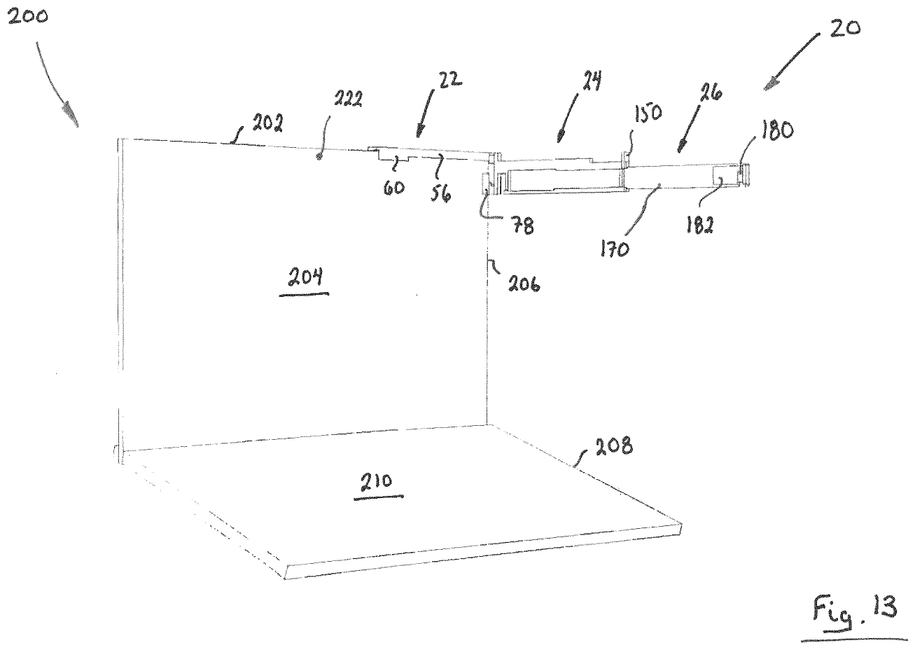

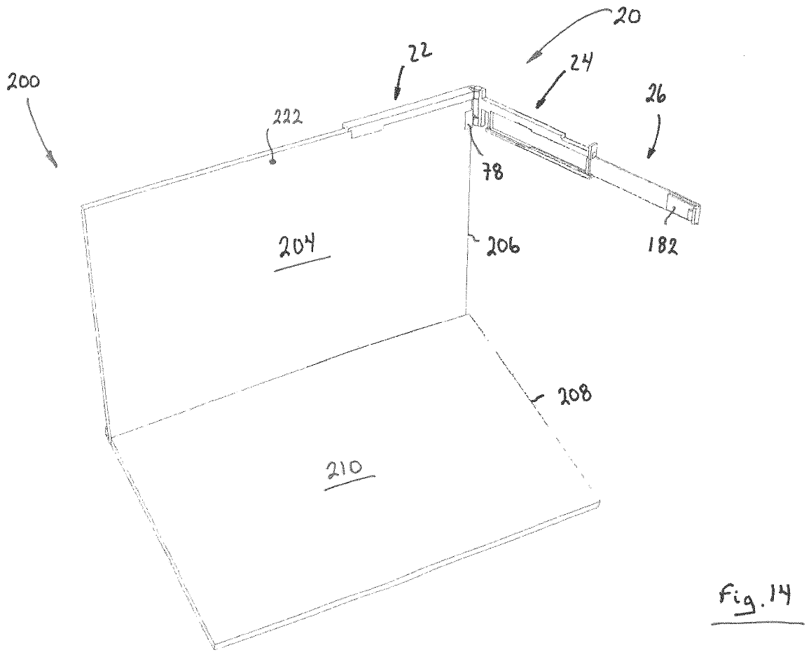

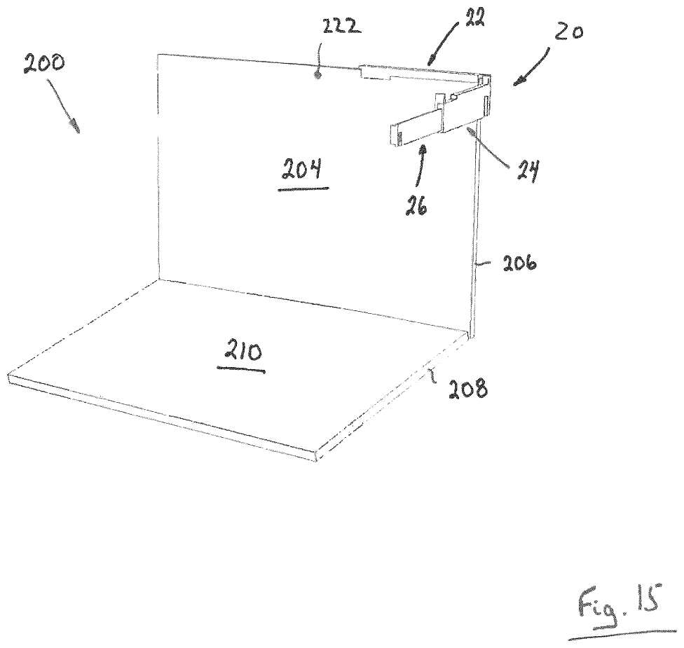

With reference to FIGS. 13 to 16, the bracket and imaging assembly 20 in the in-use extended condition is shown in conjunction with a portable computing device in the form of a laptop computer 200. In the example shown, the bracket and imaging assembly 20 is mounted on the upper edge 202 of the display component 204 of the laptop computer 200. As can be seen, the channel 64 of the attachment arm 22 defined by the front wall 56, top wall 54, and the upper portion of the rear wall 52 accommodates the upper edge 202 of the display component 204 adjacent one side of the display component 204 and the L-shaped angle 78 accommodates the side edge 206 of the display component 204.

With the attachment arm 22 mounted on the display component 204, the swing arm 24 is rotated relative to the attachment arm 22 until the detent 122 comes into alignment with the notch 76 in the lower knuckle 74. In this position, the swing arm 24 is able to slide downwardly along the hinge pin 120 so that the lower surface of the central knuckle 112 and upper surface of the lower knuckle 74 are in close proximity to one another and so that the detent 122 is received by the notch 76 thereby to inhibit further rotation of the swing arm 24. In this position, the swing arm 24 extends at a factory or calibrated designated angle relative to the attachment arm 22 so that the swing arm 24 extends beyond the side edge 208 of the keyboard and base component 210 of the laptop computer 200. If the upper surface of the lower knuckle 74 includes more than one notch 76 establishing multiple factory or calibrated designated angles, the swing arm 24 can be rotated relative to the attachment arm 22 until the detent 122 becomes aligned with desired notch 76 before allowing the swing arm 24 to slide downwardly along the hinge pin 120.

With the swing arm 24 at the desired angle relative to the attachment arm 22, the slider 26 is then extended longitudinally from the swing arm 24 until the post 172 encounters the ramp or ridge 142 inhibiting further longitudinal sliding movement of the slider 26 relative to the swing arm 24 so that the field of view (FOV) of the camera 180 is aimed downwardly at the physical desktop or surface to the side edge 208 of the laptop computer 200. As will be appreciated, the extent to which the slider 26 extends longitudinally from the swing arm 24 and the angle between the attachment arm 22 and the swing arm 24 can be adjusted to position the FOV of the camera 180 at the desired position on the physical desktop or surface allowing video or image frames of one or more documents or pages positioned on the physical desktop or surface to be captured. The cable (not shown) which is connected at one end to the printed circuit board 182 of the imaging device 28 is then plugged into the USB port of the laptop computer 200 via the USB connector to provide power to the imaging device 28 and to allow the physical desktop view of the imaging device 28 to be transmitted to the laptop computer 200.

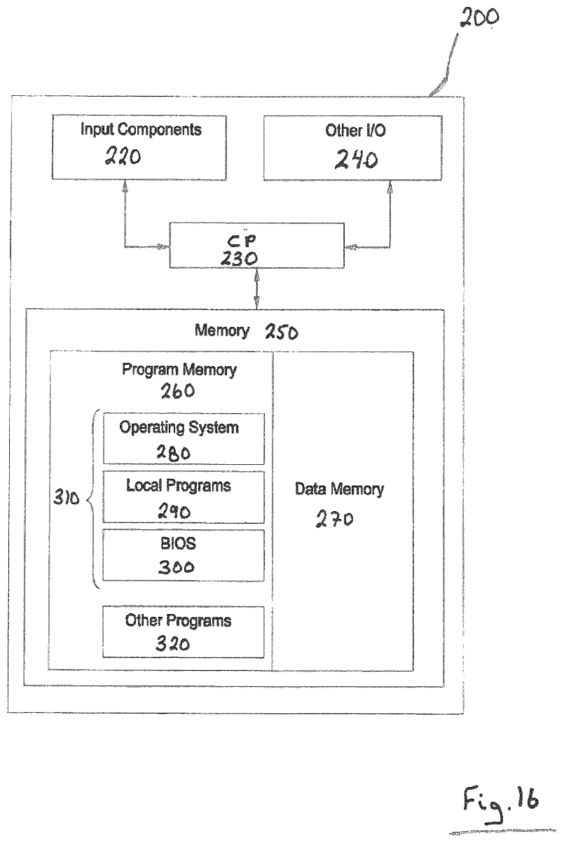

FIG. 16 best illustrates components of the laptop computer 200. The laptop computer 200 comprises input components 220 including the USB port to receive the USB connector of the cable and a camera 222 centrally positioned adjacent the upper edge 202 of the display component 204. The input components 220 may further include, for example, a mouse, a keyboard, a pointer device, one or more microphones etc.

The laptop computer 200 comprises a processor such as a central processor (CP) 230. The CP 230 may comprise a single processing unit or multiple processing units. The CP 230 is configured to receive the physical desktop view of the imaging device 28, the frontal user view of the camera 222 as well as input from other input components. The CP 230 can be coupled to other hardware components via, e.g., a bus, such as a PCI bus or SCSI bus. Other input/output components 240 of the laptop computer 200 include communication components, such as a wireless transceiver (e.g., a WiFi or Bluetooth transceiver) and/or a network card. Such communication components enable communication over wired or wireless (e.g., point-to point) connections with other devices. A network card of the laptop computer 200 enables the laptop computer 200 to communicate over a network (using, e.g., TCP/IP protocols). The input/output components 240 include the display component 204, a video card, audio card, etc. and may include external devices such as a printer, CD-ROM drive, DVD drive, disk drive, Blu-Ray device, and/or speakers.

The CP 230 has access to non-transitory memory 250 that includes volatile and non-volatile components which may be writable or read-only. For example, the memory 250 may comprise CPU registers, random access memory (RAM), read-only memory (ROM), and writable non-volatile memory, such as flash memory, hard drives, floppy disks, CDs, DVDs, magnetic storage devices, tape drives, device buffers, and so forth. The memory 250 stores programs or applications and software in program memory 260 and associated data (e.g., configuration data, settings, user options or preferences, etc.) in data memory 270. The program memory 260 contains an operating system 280, local programs 290, and a basic input output system (BIOS) 300, all of which can be referred to collectively as general software 310.

The program memory 260 also contains other programs and software 320, including specialized programs and software. In particular, in this embodiment the program memory contains a video stream or image frame merging program that is executed by the CP 230. The video stream or image frame merging program includes a “share screen” or “virtual camera” function allowing multiple video or image frame streams or views to be combined and presented as a dual view within a single window or full screen. As will be appreciated, the “share screen” function is a common feature in most remote meeting applications such as Zoom™, Teams™, Google Meet™, WebEx™ etc. Open source and commercial software applications that include the “share screen” or “virtual camera” function and allow views from multiple imaging devices to be combined and displayed within a common window and shared with remote locations are known. Example open-source applications providing this functionality include Open Broadcast Software (OBS) Studio and Streamlabs and a commercial application providing this functionality is ManyCams.

When executing the “share screen” or “virtual camera”, the video stream or image frame merging program combines the frontal user view of the camera 222 with the physical desktop view of the imaging device 28 into a dual view presented within a single window or full screen. The video stream or image frame merging program provides user controls to allow the user to control the manner in which the dual view is presented. In particular, the video stream or image frame merging program allows the orientation, placement and proportions of the frontal user view and physical desktop view to be user-defined. This allows for example the frontal user view and the physical desktop view to be presented as picture-in-picture, or picture-beside-picture. Of course, the user frontal view and physical desktop view may be presented in other forms or orientations.

In this embodiment, the video stream or image frame merging program applies image correction to the physical desktop view. The image correction may for example include (i) zoom of the physical desktop view (zoom-in or zoom-out), (ii) rotation (orientation) of the physical desktop view, (iii) shifting of the physical desktop view (left, right, up, and down), (iv) perspective correction, and/or (v) barrel distortion correction. As will be appreciated, as the video stream or image frame merging program is executed on the CP 230, the CP 230 is used to combine the frontal user view and the physical desktop view and to process the physical desktop view as needed. As a result, any heavy video processing required is handled by the laptop computer 200 allowing the imaging device 28 to be responsible for simple video or image frame capture thereby reducing the complexity of the bracket and imaging assembly 20 and as a result its manufacturing cost.

The video stream or image frame merging program in this embodiment optionally supports image registration allowing the orientation of imaged documents or pages to be determined. This can be achieved by processing image frames of the physical desktop view video stream to detect corners of the documents or pages or by detecting fiduciary markers placed on the documents or pages that can be resolved via image processing. Alternatively, artificial intelligence (AI) may be used to facilitate detection of document or page orientation.

In this embodiment, the video stream or image frame merging program can also be conditional to treat the imaging device 28 as an additional video or image frame source. In this mode, the physical desktop view of the imaging device 28 is not combined with any other camera view and is presented independently in the single window or full screen.

The frontal user view, physical desktop view, and/or combined dual view may be stored in the data memory 270 allowing the various video or image frame streams to be archived and retrieved as desired for presentation on the display component 204 and/or incorporated into documents.

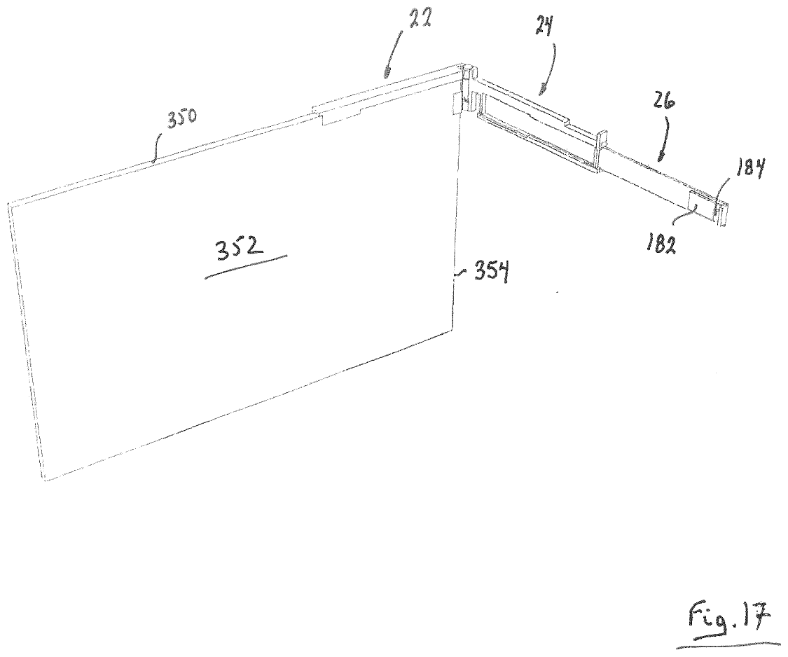

Although the bracket and imaging assembly 20 is shown in FIGS. 13 to 15 as being mounted on the display component 204 of the laptop computer 200, the bracket and imaging assembly 20 may be used in other computing environments. For example, in FIG. 17, the bracket and imaging assembly 20 is shown mounted on the upper edge 350 of a stand-alone computer monitor 352 or other display device and positioned to capture a video stream or image frames of a physical desktop surface to the side edge 354 of the computer monitor 352.

As will be appreciated by those of skill in the art, the attachment arm 22, swing arm 24 and slider 26 may be injected molded as individual parts and then assembled. The increased width of the slider channel 130 defined by the shoulders 138 facilitates sliding of the slider 36 into the slider channel 130 during assembly. Alternatively, the bracket and imaging assembly 20 may be manufactured by additive manufacturing. A common example of additive manufacturing is three-dimensional (3D) printing; however, other methods of additive manufacturing are available. Rapid prototyping or rapid manufacturing are also terms which may be used to describe additive manufacturing processes.

Suitable additive manufacturing techniques include, for example, Fused Deposition Modeling (FDM), Selective Laser Sintering (SLS), 3D printing such as by Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes.

Additive manufacturing processes typically fabricate components or assemblies based on 3D information, for example a three-dimensional computer model (or design file), of the components or assemblies. Design files can take any now known or later developed file format. For example, design files may be in the Stereolithography or “Standard Tessellation Language” (.stl) format, which was created for stereolithography CAD programs of 3D Systems, or the Additive Manufacturing File (. amf) format, which is an American Society of Mechanical Engineers (ASME) standard and which is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g., CAD modelling) software and/or through scanning the surface of a component or assembly to measure the surface configuration of the product.

Once obtained, a design file may be converted into a set of computer executable instructions that, once executed by a processor, cause the processor to control an additive manufacturing apparatus to produce the component or assembly according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator, or owner of the additive manufacturing system, or from other sources. An additive manufacturing system may execute the instructions to fabricate the component or assembly using any of the technologies or methods disclosed herein.

Design files or computer executable instructions may be stored in a non-transitory computer readable storage medium (e.g., memory, storage system, etc.) storing code, or computer readable instructions, representative of the component or assembly to be produced. As noted, the code or computer readable instructions defining the component or assembly can be used to physically generate the component or assembly, upon execution of the code or instructions by an additive manufacturing system. For example, the instructions may include a precisely defined 3D model of the component or assembly and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus can be instructed to print out one or more components of the bracket and imaging assembly 20. These can be printed either in assembled or unassembled form. For instance, different components of the bracket and imaging assembly 20 may be printed separately and then subsequently assembled. Alternatively, the different components of the bracket and imaging assembly 20 may be printed in assembled form. In this case, the shoulders 138 in the slider channel 130 are not required.

In light of the above, embodiments include methods of manufacture of the bracket and imaging assembly 20 via additive manufacturing. This includes the steps of obtaining a design file representing the bracket and imaging assembly 20 and instructing an additive manufacturing apparatus to manufacture the bracket and imaging assembly 20 in assembled or unassembled form according to the design file. The additive manufacturing apparatus may include a processor that is configured to automatically convert the design file into computer executable instructions for controlling the manufacture of the bracket and imaging assembly 20. In these embodiments, the design file itself can automatically cause the production of the bracket and imaging assembly 20 once input into the additive manufacturing device. Accordingly, in this embodiment, the design file itself may be considered computer executable instructions that cause the additive manufacturing apparatus to manufacture the bracket and imaging assembly 20. Alternatively, the design file may be converted into instructions by an external computing system, with the resulting computer executable instructions being provided to the additive manufacturing device. The instructions are suitable for execution of the processor and for storage on the non-transitory computer readable storage medium. The non-transitory computer-readable medium may comprise any suitable memory or storage device such as random-access memory (RAM), static RAM (SRAM), dynamic RAM (DRAM), non-volatile RAM (NVRAM), read-only memory (ROM), or Flash memory.

Although the imaging device 28 is shown as including a single camera 180 mounted on the slider 26, those of skill in the art will appreciate that multiple cameras may be provided on the slider 26. The multiple cameras may be served by a single printed circuit board 182 or multiple printed circuit boards may be provided. Image streams or image frames from the multiple cameras may be stitched together by the CP 230 to form a single video stream that is merged with the video stream from the camera 222 of the laptop computer 200 or the image streams from the multiple cameras may be individually merged with the video stream from the camera 222 of the laptop computer 200.

Instead of using the camera 222 of the laptop computer 200 or in addition to the camera 222 of the laptop computer 200, a separate webcam or other imaging device may be used to provide the frontal user view or an additional user view for merging with the physical desktop view provided by the imaging device 28 of the bracket and imaging assembly 20.

Although a detent and notch(es) are used to retain the angle of the swing arm 24 relative to the attachment arm 22, those of skill in the art will appreciate that other mating formations may be used to resist rotation of the swing arm 24 relative to the attachment arm 22 once the swing arm 24 is at the desired angle relative to the attachment arm.

In the embodiments described above, the dimensions of the bracket and imaging assembly 20 are such that the field of view of the camera 180 is aimed downwardly at the physical desktop when the bracket and imaging assembly 20 is mounted on the display component and in the extended in-use condition. As will be appreciated, if the field of view of the camera 180 is angled relative to the physical desktop image, correction of the physical desktop view to correct for perspective distortion may be required.

In the embodiments described above, the longitudinal axes of the attachment and swing arms 22 and 24, respectively, are at 90° with respect to the longitudinal axis of the hinge pin 120. As a result, during use when the swing arm 24 is pivotally rotated relative to the attachment arm 22 about the hinge 30, the attachment and swing arms remain at the same elevation. Those of skill in the art will appreciate that the hinge pin 120 may be angled so that when the swing arm 24 is rotated relative to the attachment arm 22 about the hinge 30, the elevation of the swing arm 24 relative to the attachment arm 22 changes.

In the examples shown, the bracket and imaging assembly 20 is of a “right-handed” design. Those of skill in the art will appreciate that a “left-handed” version of the bracket and imaging assembly is simply a mirror image of the bracket and

### Imaging Assembly 20.

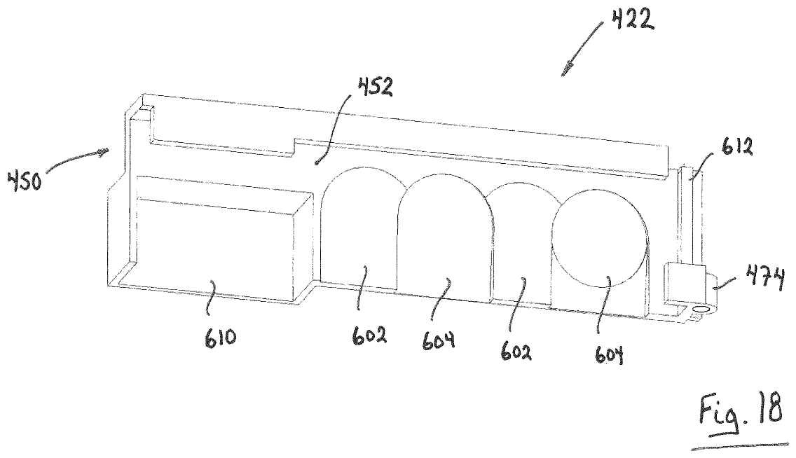

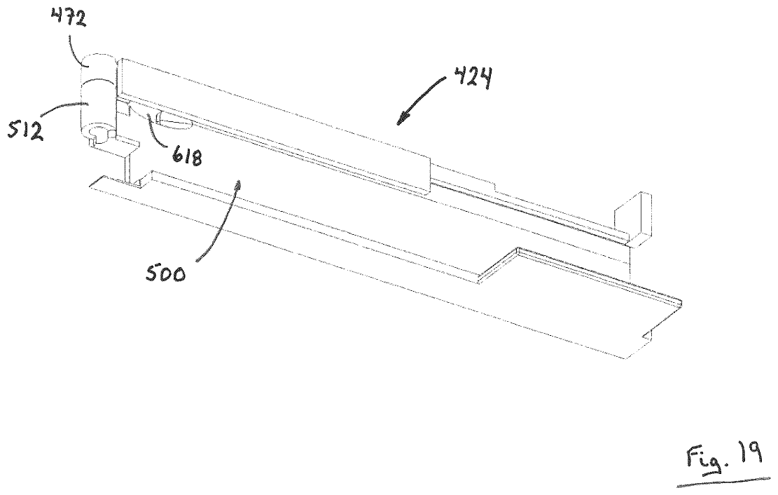

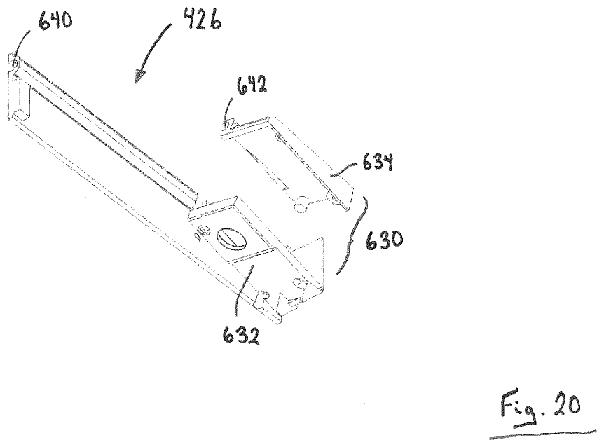

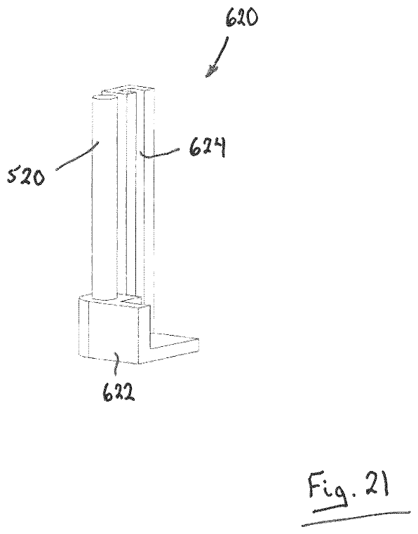

Turning now to FIGS. 18 to 21, an alternative embodiment of a bracket and imaging assembly is shown. The bracket and imaging assembly is very similar to bracket and imaging assembly 20. In this embodiment and similar to the bracket and imaging assembly 20, the bracket and imaging assembly comprises four (4) primary components, namely an attachment arm 422, a swing arm 424, a slider 426, and an imaging device (not shown). Attachment arm 422 and swing arm 424 are physically coupled via a hinge allowing the attachment arm 422 and swing arm 424 to pivotally rotate with respect to one another. Slider 426 is coupled to the swing arm 424 and is longitudinally slidable relative to the swing arm 424. The imaging device is positioned adjacent or near to the free distal end of the slider 426 and has a downwardly oriented field of view (FOV) when the bracket and imaging assembly is in engagement with the computing device display component. The field of view (FOV) of the imaging device can be aimed at a physical desktop or surface allowing documents or pages placed on the physical desktop to be imaged providing the imaging device with a physical desktop view.

In this embodiment, the rear wall 452 of the body 450 of attachment arm 422 has recesses 602 of different depths provided therein that are configured to accommodate pads 604 formed of foam, rubber or other suitable material. When the attachment arm 422 is in engagement with the upper edge of the computing device display component, the pads 604 press against the back of the computing device display component to inhibit sliding of the attachment arm 422 along the upper edge. As will be appreciated by those of skill in the art, the recesses 602 into which the pads 604 are placed are selected to accommodate the thickness of the computing device display component to which the attachment arm 422 is engaged. In this manner, standard size pads can be used while still accommodating different display component thicknesses. A rectangular compartment 610 is provided adjacent the free distal end of the body 450 to accommodate the imaging device when the attachment arm 422 and swing arm 424 are brought into making engagement and nest. The opposite end of the body 450 is configured to define components of the hinge. In particular, the end of the body 450 is configured to form the lower knuckle 474 as well as an upright rail 612.

In this embodiment, the body 500 of the swing arm 424 is also configured to define components of the hinge. In particular, the end of the body 500 includes the central and upper knuckles 512 and 472 of the hinge. A cable port 618 is provided in the body 500 adjacent the knuckles 472 and 512. A cable cover 619 extends along the top edge of the body 500 partially along its length. Unlike the previous embodiment, the hinge comprises a separate hinge component 620 comprising a base 622, upstanding hinge post 520 that extends through the knuckles 472, 474, and 512, and a channel 624 that accommodates the rail 612.

In this embodiment, the slider 426 comprises an angled enclosure 630 comprising a base 632 and a cover 634 to accommodate the imaging device. The angle of the enclosure 630 is selected so that when the slider 426 is extended longitudinally from the swing arm 424, the optical axis of the imaging device is substantially normal to the physical desktop or surface thereby to reduce distortion and hence reduce image processing load. A channel 640 extends along the top of the slider 426 and is aligned with a cable port 642 provided in the cover 634. The cable port 642 and channel 640 accommodate a cable extending from the imaging device that passes through cable port 618 facilitating connection of the imaging device to the computing device. The cable cover 619 assists to keep the cable in place when the slider 426 is extended and helps to ensure the cable does not buckle when the slider 426 is slid back into the swing arm 426. When the swing arm 424 and attachment arm 422 are pivoted relative to one another to bring them into mating engagement, the enclosure 630 is received by the compartment 610.

If desired, the bracket and imaging assemblies may be used as an alternate user interface to allow users to interact with documents within the fields of view of the imaging devices. For example, users can draw on pages within the imaging device fields of view and an artificial intelligence (AI) application running on the computing device may generate a corresponding image. Alternatively, the computing device may employ object and character recognition to convert the drawing into a form for insertion into documents.

Although embodiments have been described above with reference to the accompanying drawings, those of skill in the art will appreciate that other variations modifications may be made.

1. A bracket and imaging assembly comprising:
an attachment arm configured to engage a computing device component;
a swing arm hinged to the attachment arm and pivotable relative thereto between an extended condition and a collapsed condition;
a slider accommodated by the swing arm, the slider being slidable longitudinally relative to the swing arm between a retracted condition and an extended condition; and
an imaging device on the slider.

2. The bracket and imaging assembly according to claim 1, wherein in the retracted condition, the slider and imaging device are accommodated by the swing arm.

3. The bracket and imaging assembly according to claim 2, wherein in the collapsed condition, the swing arm and the attachment arm matingly engage.

4. The bracket and imaging assembly according to claim 1, wherein when the swing arm and the slider are in extended conditions, the imaging device is configured to image a physical desktop or surface.

5. The bracket and imaging assembly according to claim 1, wherein the attachment arm is configured to engage a display component of the computing device.

6. The bracket and imaging assembly according to claim 5, wherein the attachment arm is configured to engage the display component of a portable computing device.

7. The bracket and imaging assembly according to claim 5, wherein the attachment arm comprises a channel configured to accommodate an upper edge of the display component.

8. The bracket and imaging assembly according to claim 7, wherein the channel frictionally engages the upper edge of the display component.

9. The bracket and imaging assembly according to claim 1, wherein the imaging device comprises at least one camera having at least one lens.

10. The bracket and imaging assembly according to claim 9, wherein the at least one camera is one of removably attached to the slider and fixedly attached to the slider.

11. The bracket and imaging assembly according to claim 9, wherein the at least one camera is connectable to the computing device via a universal serial bus (USB) connection.

12. The bracket and imaging assembly according to claim 1, further comprising a retaining mechanism to maintain the angle of the swing arm relative to the attachment arm in the extended condition.

13. The bracket and imaging assembly according to claim 12, wherein the retaining mechanism comprises mating formations carried by the swing arm and the attachment arm.

14. The bracket and imaging assembly according to claim 1, wherein the swing arm comprises a channel in which the slider slides and wherein the channel comprises a stop to limit longitudinal extension of the slider relative to the swing arm.

15. The bracket and imaging assembly according to claim 1, further comprising at least one non-transitory computer readable medium embodying instructions, which when executed by one or more processing units, causes the one or more processing units to merge a video stream or image frames captured by the imaging device with a video stream or image frames captured by another imaging device.

16. The bracket and imaging assembly according to claim 15, wherein the video stream or image frames captured by the imaging device is a physical desktop view and wherein the video stream or image frames captured by another imaging device is a user view.

17. The bracket and imaging assembly according to claim 15, wherein another imaging device is a camera of the computing device.
